(19) United States
(12) Patent Application Publication
(10) Pub. No.: US 2004/0173991 A1
(43) Pub. Date: Sep. 9, 2004

(54) Composite frame member and frame for a wheelchair

(75) Inventors: Simon B. L. Watterton, Hofstetten (CH); Rainer Kueschall, Sissach (CH)

Correspondence Address: BROWDY AND NEIMARK, P.L.L.C., 624 NINTH STREET, NW, SUITE 300, WASHINGTON, DC, 20001-5303, US

(73) Assignee: KUSCHALL AG, Allschwil (CH)

(21) Appl. No.: 10/791,702

(22) Filed: Mar. 4, 2004

(30) Foreign Application Priority Data
Nov. 28, 2003 (EP) 03 027 238.9
Mar. 4, 2003 (EP) 03 004 733.6

(51) Int. Cl. B62K 1/00

(52) U.S. Cl. 280/281.1

(57) ABSTRACT

L-shaped frame member and frame for a wheelchair. The frame member comprises a first arm with a first cross section, a second arm with a second cross section, and a knee-shaped composite element. The first arm is connected to the second arm via the knee-shaped composite element. A firm connection between the first arm and the knee-shaped composite element and a solid connection between the second arm and the knee-shaped composite element being formed by portions of a mounting glue).

### CROSS REFERENCE TO RELATED APPLICATIONS

Priorities are claimed of the European patent application 03 004 733.6, as filed on 4 Mar. 2003, and the European patent application 03 027 238.9, as filed on 28 Nov. 2003, incorporated herein by reference.

The present invention relates to an L-shaped frame member for a wheelchair in accordance with claim 1 and a frame for a wheelchair in accordance with claim 12.

### FIELD AND BACKGROUND OF THE INVENTION

Wheelchairs usually have frames comprising frame members which are made of bent tubes. Many frames comprise a knee-like frame member having the form of an inversed letter L, with a first tube portion being essentially horizontal and a second tube portion being essentially vertical. The angle between the first and second portions may differ considerably from 90°, and the two frame portions adjacent the corner portion are not necessarily totally straight but may be slightly bent too, although with a curvature which is considerably smaller than the curvature of the corner area where they meet.

Frames of this type are practical, esthetic, easy to make and not costly, but frame members in the form of a letter L have a severe drawback: the stress-resistance of the different portions is not adjusted to the stress they have to bear. The maximum stress is in the corner area where the two arms of the letter L meet, while the stress resistance in this area is reduced due to the bending operation. Further, the stress to be supported by the upright arm usually is lower than the stress to be supported by the horizontal arm, yet the stress resistance of both arms is equal. In consequence, a tube must be chosen having a stress resistance which is high enough, also in bent state in the corner area of the letter L, to support the maximum stress. Such a tube is over-dimensioned in view of it's stress resistance for the arm portions of the frame member. This is in contradiction to the general requirement that wheelchairs and especially their frames should be light-weight constructions, where no portion should be over-dimensioned.

### OBJECT OF THE INVENTION

It is an object of the invention, to propose

an enhanced frame member for a frame of a wheelchair in form of a letter L, which does not comprise the drawbacks of the prior art members of this type, and

a frame for a wheelchair comprising at least one of the frame members in accordance with the invention.

### SUMMARY OF THE INVENTION

This object is attained

with a frame member in accordance with the invention, comprising the features of claim 1, and

with a frame in accordance with claim 12.

Details and preferred embodiments of the invention are defined in the dependent claims.

The new frame member comprises four elements, (i) a first arm, which is preferably straight or slightly bent and preferably made of a tube, with a first cross section, (ii) a second arm, which is preferably straight or slightly bent, and preferably made of another tube, with a second cross section, (iii) an L-shaped corner element made of a composite, with end areas having curvatures corresponding to the end areas of the first and second arms respectively, and (iv) two portions of a mounting glue to connect firmly the end areas of the corner element with the end areas of the first and second arms respectively. The first cross section (size and/or shape) and the second cross section (size and/or shape) are different.

The stress resistance, i.e. the material and the cross sections of the corner element and the first and second arms, are adapted to the stress they have to bear, so that any over-dimensioning is avoided and the frame member is a light-weight construction.

The cross sections (size and/or shape) of the first and second arms are different, whereby the corner element is shaped to provide for the change in cross section.

The longitudinal axles or central lines of the two arms, which also may be slightly curved, can be in one plane, in parallel planes or in warped planes.

In a preferred embodiment, the first and second arms are hollow and have thin walls, and they may be extruded or deep-drawn; they are preferably made of tubes, with an inner cross section corresponding to outer cross sections of the end areas of the composite corner element. The corner element may be solid or may be tube-like, but then usually with a considerable wall thickness. The end areas of the corner element are introduced in the first and second arms, respectively.

The end areas of the first and second arms usually need not to be specially machined but have the same cross sections than the rest of the arms.

Preferably, the form and dimension of the outer surfaces of the end areas of the corner element are equal to the form and dimension of the outer surfaces of the adjacent portions, so that the frame member has a surface without protruding edges.

The term ‘mounting glue’ is used for any gluing or cementing material which is able to connect firmly the arms, which are made of a metal like steel or a material comprising aluminum, magnesium or titanium, with the corner element which is made of a composite material and may comprise reinforcing nets, or fibers like carbon fibers and/or Kevlar, whereby the fibers preferably are positioned along the corner element. The corner element may also comprise plastic. The mounting glue, however, should not be more brittle than either of the arms and the corner element.

The mounting glue is applied to an area delimited by the end portions of the knee-shaped composite corner element of the first and second tube, respectively, preferably in a recess or cavity in which the mounting glue is mainly situated. It has been found a good solution to position the recess or cavity for the mounting glue at a surface of the knee-shaped composite corner element.

In cases where the mounting glue is applied after inserting the inner portions of the frame member into the outer portions of the frame member, glue channels may be necessary to feed the mounting glue to it's appropriate position.

One or all of the surfaces which are in contact with the mounting glue can be slightly structured to enhance the effective contact surface and the effect of the mounting glue.

Although it is possible to provide for a sufficiently strong connection between the arms and the corner element by means of a mounting glue, it may in certain cases be recommended to provide the surfaces of the arms and the corner element which are in contact with a structure in form of projections and recesses in the mounting direction, whereby the projections and recesses may be straight or may have a spin. By this a rotational movement between meeting elements is prevented.

In addition to the connection by means of mounting glue, it may be recommended in certain cases to use fixation elements like pins or the like to prevent mutual rotating or shifting of the elements which are connected by the mounting glue.

The frame element is used as a part of a frame of a wheelchair. In the assembled wheelchair, preferably one of the arms is in an essentially upright position and the other of the arms is in an essentially horizontal position.

It is a further benefit of the invention, that the arms and/or the corner element are designed in view of their shape and/or dimension and/or stress resistance to allow different other elements of the wheelchair to be affixed to or integral with them, like e.g. a wheelchair seat element, a wheelchair backrest, a wheelchair braking arrangement, a suspension element with front wheel, a foot rest, lever, or bar, or a seat frame portion.

### BRIEF DESCRIPTION OF THE DRAWINGS

The frame element in accordance with the invention will now be described with reference to the drawings, wherein

FIG. 1 shows a frame member in a section comprising it's curved longitudinal axis, in schematic representation;

FIG. 2A shows a portion of a wheelchair with two frame members in accordance with the invention, in a lateral view;

FIG. 2B shows the cross section A2 of the essentially vertical arm of the frame member of FIG. 2A, enlarged; and

FIG. 2C shows the cross section A1 of the essentially horizontal arm of the frame member of FIG. 2A, enlarged.

### DESCRIPTION OF THE PREFERRED EMBODIMENTS

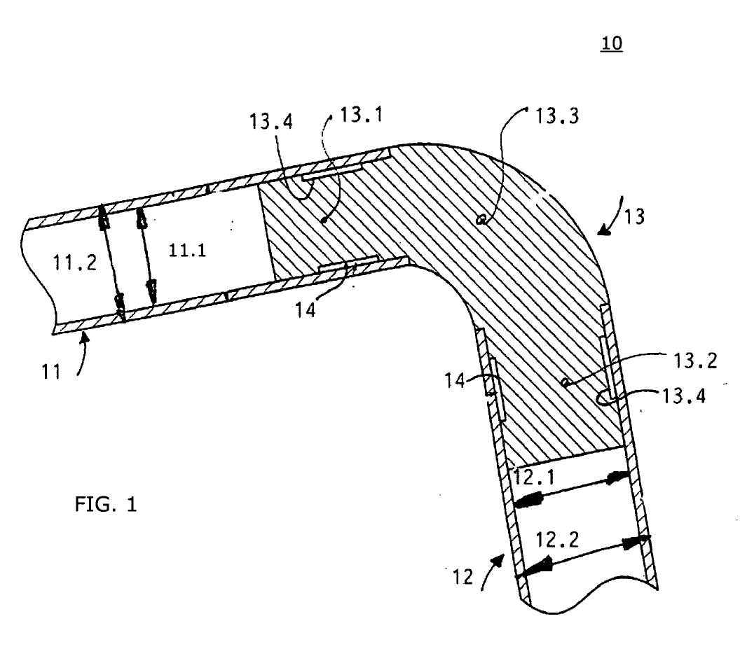

A frame member 10, depicted in FIG. 1, comprises a first arm 11 which is made of a straight tube and has a first inner diameter 11.1 and a first outer diameter 11.2 and a second arm 12 which is also made of a tube and has a second inner diameter 12.1 and a second outer diameter 12.2. The cross sections of the tubes are not necessarily cylindrical, and instead of tubes parts having only hollow end portions may be used.

The frame member 10 further comprises a knee-shaped or corner element 13. The knee-shaped corner element 13 comprises a first end area 13.1 which is introduced in the first arm 11, and a second end area 13.2 which is introduced in the second arm 12. Between and adjacent to it's straight end areas 13.1 and 13.2, the corner element 13 further comprises an effectively knee-shaped or strongly curved area 13.3. The corner element 13, in the depicted embodiment, is a solid piece, but it may also be tube-like or it may have cavities.

With a corner element having at least end-areas which are hollow, it is possible to introduce the arms into the corner element instead of introducing the corner element into the arms, whereby the arms in this case can be solid parts.

The outer surface of the first end area 13.1 of the corner element 13 essentially corresponds to the inner surface of the first arm 11, and, the outer surface of the second end area 13.2 of the element 13 essentially corresponds to the inner surface of the second arm 12, so that the frame portion 10 as a whole has a smooth outer surface without any edges.

Not only the diameters, as shown in FIG. 1, but also the shapes and dimensions of the first arm 11 and the second arm 12 may be different from each other, as long as a corner element 13, providing for the necessary change of the cross sections, can be produced with a sufficient stress resistance.

The end portions of the first arm 11 and the second arm 12 are not specially formed, although they may be slightly machined for easier introducing the corner element 13.

The end portions 13.1 and 13.2 of the corner element 13 have reduced outer diameters which correspond to the inner diameters 11.1, 12.1 of the arms 11 and 12, respectively. As already mentioned, the outer diameter of the remaining, effectively cornered area 13.3 of the corner element 13 increases from the outer diameter of the first arm 11 to the outer diameter of the second arm 12.

The end areas 13.1 and 13.2 of the corner element 13 each comprise for example a recess 13.4 in their surface which faces the adjacent arm 11 or 12, respectively. The recess 13.4 contains all or at least a major part of a mounting glue 14 by means of which the corner element 13 is connected with the arms 11 and 12, respectively. Alternately, the recess can be arranged in the end areas of the arms 11, 12, or be delimited by one of the arms 11, 12 and the corner element 13.

The length of the overlapping portions of the corner element 13 with the arm 11 or 12, respectively may be around 45 mm, and a medium diameter of the corner element may be around 30 mm.

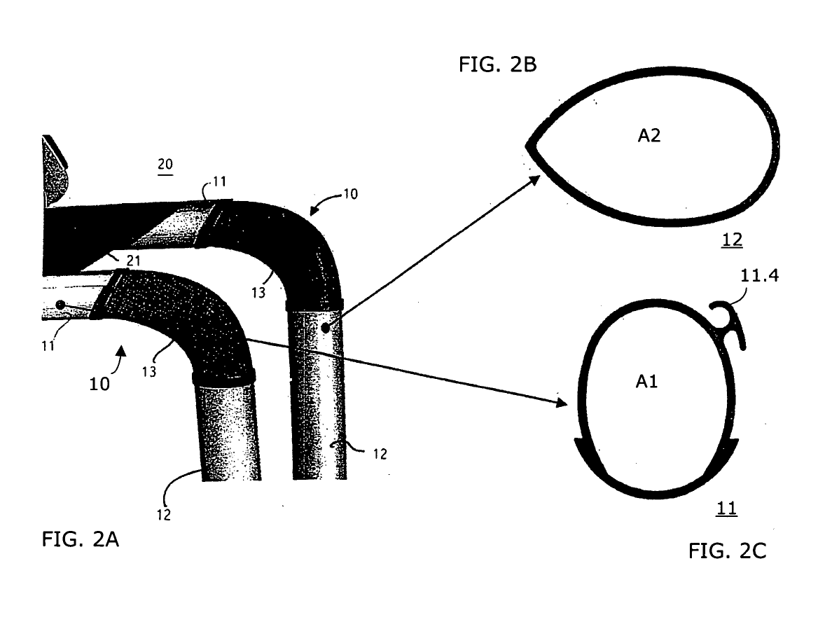

FIG. 2A shows a portion of a wheelchair 20, with two frame members 10 of the invention and a seat 21. The frame members 10 each comprise a first arm 11 made of a tube with a first cross section A1, a second arm 12 made of a tube with a second cross section A2, and a knee-shaped corner element 13 in form of an inversed letter L made of a composite. The details of the adjacent areas and the connection by mounting glue may correspond to what has been described with relation to FIG. 1 and are not further explained.

FIG. 2B shows the cross section A1 of the arm 12, which is streamline shaped.

FIG. 2C shows the cross section A2 of the arm 11, which has a projection 11.4, specially designed to mount the seat 21.

In an advantageous embodiment, the knee-shaped composite element 13 comprises several layers of a reinforced material. These layers comprise glas and/or carbon and/or kevelar fibers as reinforcing material.

In a preferred embodiment, a knee-shaped foam element is used to produce the knee-shaped composite element 13. Well suited is a polyurethan (PU) foam, such as a 2K PU foam, for example, since this foam forms closed pores. Several layers are applied on the knee-shaped foam element and are treated with a resin that hardens. The layers may have the form of socks which are put on the knee-shaped foam element. Preferably, the knee-shaped foam element with one or more layers applied is put in a tool that allows the resin to be injected. After the resin is hardened, the tool is opened to remove the knee-shaped composite element 13. According to this preferred embodiment, the foam element remains inside the knee-shaped composite element 13 and provides for additional stability.

Best results have been achieved with 3 or 4 layers of reinforcing material. Depending on the kind of resin used, it is advantageous to apply a thin finishing layer that serves as UV protection. The resin and/or the finishing layer may be colored using pigments or dyes.

1. L-shaped frame member for a wheelchair, said frame member comprising
a first arm with a first cross section,
a second arm with a second cross section, and a
knee-shaped composite element, wherein
said first arm is connected to said second arm via the knee-shaped composite element, a solid connection between the first arm and the knee-shaped composite element and a solid connection between the second arm and the knee-shaped composite element being formed by mounting glue, and wherein
the knee-shaped composite element provides for a change in cross section.

2. The frame member of claim 1,
wherein the first arm and/or the second arm is a tube or has a hollow end area, preferably in form of a tube, wherein the tubes preferably are thin-walled tubes.

3. The frame member of claim 1,
wherein the first cross section is chosen to allow one or more of the following units to be attached to or to be connected with the first tube:
a wheelchair seat element;
a wheelchair backrest;
a wheelchair braking arrangement.

4. The frame member of one of claim 1,
wherein the second cross section is chosen to allow one or more of the following units to be attached to or to be connected with the second tube:
a suspension element with front wheel;
a foot rest, lever, or bar;

5. The frame member of claim 1,
wherein the first arm and/or the second arm comprise aluminum, titanium, or magnesium.

6. The frame member of claim 1,
wherein the first arm and/or the second arm are deep-drawn, or extruded tubes.

7. The frame member of claim 1,
wherein the knee-shaped composite element is at one end partially situated inside the first arm and at the other end partially situated inside the second arm, providing for an overlap between the respective arm and end areas of the knee-shaped composite element.

8. The frame member of claim 7,
wherein the mounting glue is situated in an area between the end portions of the knee-shaped composite element and of the first and second arm, respectively.

9. The frame member of claim 7,
wherein the end portions of the knee-shaped composite element comprise a recess or a cavity in which the mounting glue is mainly situated.

10. The frame member of claim 8, wherein the end portions of the knee-shaped composite element comprise a recess or a cavity in which the mounting glue is mainly situated.

11. The frame member of claim 1, wherein the knee-shaped composite element comprises reinforcing fibers like carbon fibers and/or Kevlar.

12. Frame of a wheelchair comprising a frame member of claim 1, wherein preferably one of the arms is essentially upright and the other of the arms is essentially horizontal.
